(19) United States
(12) Patent Application Publication
(10) Pub. No.: US 2009/0146545 A1
(43) Pub. Date: Jun. 11, 2009

(54) LOW-MERCURY-CONSUMING FLUORESCENT LAMPS

(75) Inventors: A. Gary Sigai, Salina, KS (US); David C. Nesting, Salina, KS (US)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/718,178

(22) PCT Filed: Oct. 26, 2005
(86) PCT No.: PCT/IB05/53514

§ 371 Date: Apr. 27, 2007

Related U.S. Application Data
(60) Provisional application No. 60/623,747, filed on Oct. 29, 2004.

(51) Int. Cl. H01J 1/62

(52) U.S. Cl. 313/486

(57) ABSTRACT

A low mercury consumption electric lamp is provided having a layer of a luminescent material which contains a phosphor blend having (1) about 50% by weight of the phosphor blend of a halophosphate phosphor wherein the average particle size of about 25% to 35% or more of the phosphor particles is about 3.3 to 4.0 microns or less, and (2) optionally, an intermediate layer of a Y, Sr, and borate material between the lamp surface and the phosphor layer.

This invention relates to low pressure mercury vapor fluorescent lamps.

Low pressure mercury vapor lamps, more commonly known as fluorescent lamps, have a lamp envelope with a filling of mercury and rare gas to maintain a gas discharge during operation. The radiation emitted by the gas discharge is mostly in the ultraviolet (UV) region of the spectrum, with only a small portion in the visible spectrum. The inner surface of the lamp envelope has a luminescent coating, often a blend of phosphors, which emits visible light when impinged by the ultraviolet radiation.

There is an increase in the use of fluorescent lamps because of reduced consumption of electricity. To further reduce electricity consumption, there is a drive to increase efficiency of fluorescent lamps, referred to as luminous efficacy which is a measure of the useful light output in relation to the energy input to the lamp, in lumens per watt (LPW).

Thus, more efficient and longer life fluorescent lamps are desired. However, significant excess of mercury is introduced into the lamp to meet desired long lamp lifetime of 20,000 hours or more. This is necessary because different lamp components, such as the glass envelope, phosphor coatings and electrodes use up the mercury in the lamp. Such increased use of mercury is not desirable and is detrimental to the environment. Accordingly, there is a drive to reduce mercury consumption in fluorescent lamps without a reduction in the lamp life.

An example of a successful lamp with reduced mercury consumption is the Alto Econowatt fluorescent lamp. In such conventional Alto lamps, the phosphor layer for a conventional F34T12 straight Econowatt fluorescent lamp, for example, is preferably a large particle-sized (having an average particle size of about 12 to about 16 microns) cool-white calcium halophosphate phosphor formed from a coating which comprises calcium halophosphate activated with manganese and antimony.

Similarly, the phosphor layer for a conventional Alto T12TLU U-bend fluorescent lamp of cool-white color contains a two phosphor mix of about 50% cool-white calcium halophosphate activated with antimony and manganese as described above, and about 50% fines (having an average particle size of about 4 to about 7 microns) of cool-white calcium halophosphate activated with manganese and antimony. The fines are a by-product of the manufacturing of conventional halophosphate phosphor. They are a fine particle fraction removed during the final stage of manufacturing. The fines are normally used only to achieve good adhesion particularly in the convoluted or bent areas between the glass layer or coatings thereon and the phosphor layer.

We have also discovered that the color obtained from the conventional large particle phosphor blend can be achieved by a phosphor derived from a mixture of fines of warm-white calcium halophosphate phosphor having an average particle size of about 4.62 microns, small-particle blue-halo calcium halophosphate phosphor having an average particle size of about 6.6 to about 10 microns, and calcium-yellow calcium halophosphate phosphor having an average particle size of about 9.0 to about 13 microns. It has been found further that using this phosphor blend makes it possible to achieve good adhesion in the manufacture of convoluted lamps of the U-bend type while using low mercury doses in the fluorescent lamp making it environmentally benign. Such phosphors form the subject of our prior application Ser. No. 10/259,713, filed Sep. 27, 2002.

In addition, we have also discovered that low mercury consumption lamps may be provided with a phosphor consisting of cool white calcium halophosphate activated with antimony and manganese having an average particle size of about 8 to about 12 microns; and a two phosphor blend of about 50% white calcium halophosphate activated with antimony and manganese and about 50% blue halo calcium halophosphate phosphor activated with antimony, wherein the blue halo phosphor has an average particle size of about 6.6 to about 10 microns. Such phosphors and lamps derived therefrom form the subject of U.S. Pat. No. 6,683,406 issued Jan. 27, 2004.

There is a continued need for fluorescent lamps with reduced mercury that pass the TCLP standards.

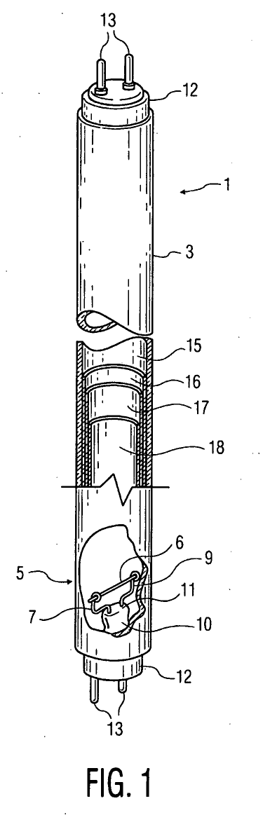

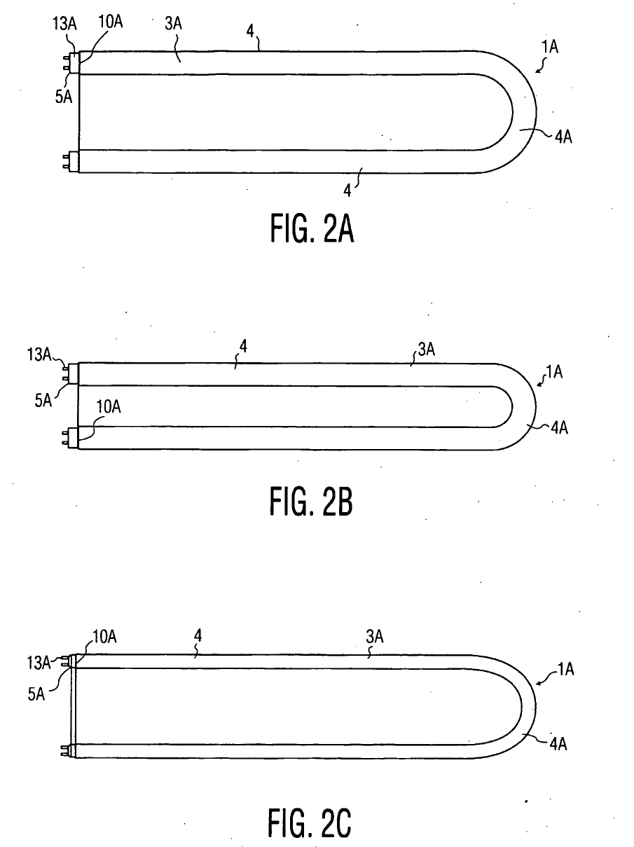

The present invention provides fluorescent lamps with reduced mercury consumption having an envelope with an inner surface and at least one electrode located at an end of the envelope, or alternatively two electrodes located at both ends of an envelope tube. The lamp may be a straight fluorescent tube, for example of the type as illustrated in the embodiment of the invention shown in FIG. 1 such as T12 straight Econowatt lamps, or it may be a lamp that includes an envelope of convoluted configuration to a desired shape such as an envelope having at least two straight leg segments joined by a U-bent section as illustrated in the embodiment of the invention shown schematically in FIG. 2 such as, for example a T12TLU, PL, Circleline, or SLS lamp, etc. Another important embodiment is the phosphor double-coat U-bend lamps, specifically of the FB32T8 variety that employ a base phosphor coat of the 50%/50% halophosphor, as described above, over which a triband phosphor blend is applied. This triband phosphor mixture can consist of, but is not limited to, Europium-doped yttrium oxide (commonly represented by YOX), cerium/terbium lanthanum phosphate (commonly represented by LAP), and Europium-doped barium/magnesium aluminate (represented by BAM). Other phosphor double-coat and triband compositions may be used including those disclosed in U.S. Pat. No. 4,431,941 issued Feb. 14, 1984.

In either embodiment, the electrodes transfer electric power to generate ultraviolet radiation in the envelope which is filled with mercury and a charge sustaining gas. A phosphor layer is formed over the inner surface, which optionally, may contain an intermediate layer comprising a metal phosphate or metal borate, with the metal being Sc, Y, La, Gd, Lu and Al, or combinations thereof, to convert the ultraviolet radiation to visible light. When the lamp is convoluted, it is preferred that the intermediate layer be a Y, Sr, borate material.

Suitable materials for such intermediate layer may be as described in WO 03/100821 when applied to straight tube fluorescent lamps. In the case of bent tube fluorescent lamps, it is known from our experiments that certain alumina precoats that function as a barrier and are effective to reduce mercury consumption in straight T12 lamps cannot withstand the bending process when applied to bent fluorescent lamps. According to the present invention, the provision of a phosphor blend containing superfines (i.e., extremely fine, eg, less than about 3.3 to 4.0 micron extra fine particle halophosphate phosphor distributions) (or such superfines-containing phosphor used in combination with a Y,Sr,borate intermediate layer or such superfines-containing phosphor used in combination with a Y,Sr,borate intermediate wherein a triband phosphor blend applied over said superfines-containing phosphor layer) is especially advantageous in withstanding the bending process and in lowering mercury consumption. Yttrium, Strontium, Borate as an intermediate layer has been used for CFL lamps and is well known in the art. It is made, for example, from precursors of yttrium acetate, strontium acetate, and boric acid.

Other components may be present in the blend and/or coated as layers in the lamp construction as long as they do not detract from or prevent the flexibility of the tube when bent or the low-mercury consumption properties otherwise obtained by the invention.

According to an embodiment of the present invention, a novel low-mercury-consuming fluorescent lamp is provided comprising:

(1) a first phosphor layer of about 50% by weight of a phosphor blend of a halophosphate phosphor wherein the average particle size of about 25% or more of the phosphor particles is about 3.3 to 4.0 microns or less, and

(2) optionally, an intermediate layer of a Y, Sr, and borate material between the lamp surface and the first phosphor layer, and/or

(3) optionally, a layer of an intermediate layer of a Y, Sr, and borate material between the lamp surface and the first phosphor layer wherein a triband phosphor blend is applied over said first phosphor layer.

In especially advantageous embodiments of the invention, the halophosphate phosphor blend comprises about 50% by weight of the phosphor blend of a halophosphate phosphor wherein the average particle size of about 35% or more of the phosphor particles is about 3.3 microns or less.

In other especially advantageous embodiments of the invention, the halophosphate phosphor blend comprises:

(1) about 50% by weight of a calcium halophosphate phosphor wherein the average particle size of about 25% or 35% or more of the phosphor particles is about 3.3 to 4.0 microns or less or about 3.3 microns or less, and

(2) about 50% by weight of a calcium halophosphate phosphor wherein the average particle size is larger than about 3.3 to 4.0 microns.

Essentially, the lamp comprises a halophosphate phosphor having a fraction with a particle distribution and size that is much finer than that normally used to produce straight TL or bent fluorescent lamps. Mercury consumption measurements show that at 1,000 hrs of burn the mercury consumption in the lamps of the invention is significantly reduced by the addition of these superfines particle phosphor distributions. This 1000-hour consumption is an indicator of a much longer life lamp. It has been found that the invention provides a phosphor material with a defined particle size distribution that leads to a reduced mercury consumption and longer lamp life using the level of mercury dosing of the lamp that is required to meet the TCLP test for disposal of the lamp as non-hazardous waste.

This reduction in mercury consumption is determined by the quantity of mercury which is bound on lamp components during operation of the lamp and is thus no longer available for operation of the lamp. As a result of the invention, it is possible to reduce the amount of mercury to be doped in Econowatt or T12TLU lamps making such lamps more environmentally benign and TCLP compliant.

In lamps of the invention, the initial dose of elemental mercury is provided in such a quantity that:

(A) after about 1,000 hours of lamp operation a sufficient quantity of elemental mercury is available to support a column discharge, and
(B) after said lamp is (1) pulverized into granules having a surface area per gram of pulverized material equal to or greater than 3.1 cm² or having a particle size smaller than 1 cm for the narrowest dimension of said particle and (2) the pulverized material is subjected to a sodium acetate buffer solution having a PH of approximately 4.9 and a weight 20 times that of the pulverized, the TCLP standard. Applicants have discovered that as a result of the use of the phosphors comprising the super-fines in a fluorescent lamp as described, TCLP-qualifying standard life lamp can be achieved by selecting the initial dose at a level which is significantly lower than lamps currently available in the market.

This is a real advantage, since the lamps pass the TCLP test through actual reduction in the amount of mercury in the lamp.

Thus the invention in other embodiments encompass an electric lamp which comprises:

a lamp envelope having an inner surface;

a source within the lamp envelope for generating ultraviolet radiation; and

a first layer of a luminescent material comprising a phosphor comprising:

(1) about 50% by weight of a cool-white calcium halophosphate phosphor wherein the average particle size of about 25% or 35% or more of the phosphor particles is about 3.3 to 4.0 microns or less or about 3.3 microns or less,

(2) about 50% by weight of a cool-white calcium halophosphate phosphor wherein the average particle size is larger than about 3.3 to 4.0 microns, and

optionally, an intermediate layer of a Y, Sr, and borate material between the lamp envelope surface and the first phosphor layer, or

optionally, a layer of an intermediate layer of a Y, Sr, and borate material between the lamp envelope surface and the first phosphor layer wherein a triband phosphor blend is applied over said first phosphor layer.

FIG. 1 is a perspective view of one embodiment of a fluorescent lamp according to the invention, partly in cross-section, partly broken away.

FIGS. 2A, 2B and 2C are perspective views of U-bend fluorescent lamps according to an embodiment of the invention.

FIGS. 2D and 2E are perspective views of fluorescent lamps having envelopes of convoluted circular configurations according to an embodiment of the invention.

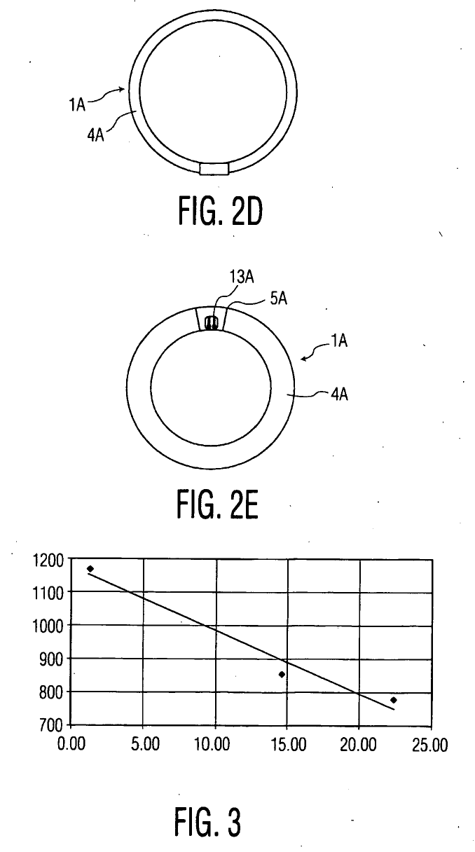

FIG. 3 is a graph illustrating the mercury consumption as a function of a superfines fraction.

The figures are diagrammatic and not to scale.

The invention will be better understood with reference to the details of specific embodiments that follow:

With reference to FIG. 1, there is illustrated a low pressure mercury vapor fluorescent lamp 1 with an elongated lamp vessel, or bulb, 3. The bulb is of a conventional soda-lime glass. The lamp includes an electrode mount structure 5 at each end which includes a coiled tungsten filament 6 supported on conductive feed-throughs 7 and 9 which extend through a glass press seal 11 in a mount stem 10. The mount stem is of a conventional lead-containing glass. The stem 10 seals the envelope in a gas tight manner. The leads 7, 9 are connected to the pin-shaped contacts 13 of their respective bases 12 fixed at opposite ends of the lamp.

Optionally, particularly in the case of U-bent lamps or lamps of convoluted configuration as illustrated in FIGS. 2A-2B, the inner surface 15 of the outer envelope 3 is provided with an intermediate layer 16 of a Y, Sr, and borate material between the lamp surface and the phosphor layer. A phosphor layer 17 comprising a superfines fraction as described above is disposed over the intermediate layer 16. Optionally, also, if desired, a triband phosphor layer 18 is disposed over the phosphor layer 17. The phosphor layers 17 and 18 and the intermediate layer 16 extend the full length of the bulb, completely circumferentially around the bulb inner wall. The stems 10 are free of any of the above layers.

The discharge-sustaining filling includes an inert gas such as argon, or a mixture of argon and other gases, at a low pressure in combination with a quantity of mercury to sustain an arc discharge during lamp operation.

According to a particular embodiment, the lamp shown in FIG. 1 is an F34T12 ECONOWATT lamp.

According to another, the lamps shown in FIGS. 2A-2D are T12TLU, T8TLU and Circleline fluorescent lamps. Although illustrated herein with cool-white phosphors, the invention has application in lamps of other colors such as warm-white halophosphate and other halophosphate phosphors.

### EXAMPLE

Two groups of F40T12 ECONOWATT lamps were made differing only in the average particle sizes and particle size distributions of the cool white phosphors employed. The lamps were provided with a filling of 4.4 mg. of mercury. After 1000 operating hours, the total amount of bound mercury was determined. The results of the mercury consumption tests are given in Table I, which illustrates the particle size distribution of the conventional phosphors and the phosphors of this invention.

In the Table:

(1) the values for mercury consumption are for 50%/50% phosphor mixtures coated into T12 cool-white Econowatt lamps for columns labeled “Fines”. The columns labeled “small particle” and “regular” are not blends but are rather 100% of these phosphor types.

Another feature of this invention is that a larger percentage of the fines phosphor can be used to achieve even lower mercury consumption in which the lower mercury appears to depend directly on the fines addition. This also provides a larger amount of superfines. However, such lowering of mercury consumption and addition of fines and superfines has been found to lead to a lower lamp lumen output which must be considered accordingly. The embodiment of the invention wherein addition of fines and superfines in a 50%/50% phosphor blend is applied over an intermediate layer of a Y, Sr, and borate material and in which a triband phosphor blend is applied over the 50%/50% phosphor blend, particularly in FB32T8 U-bent lamp, has been demonstrated to reduce mercury consumption without significantly affecting lumen performance. It has been found that best results are achieved when the phosphor blends comprise 50% of conventional cool-white calcium halophosphate having an average particle size of about 8.0 to about 12.0 microns and 50% fines cool-white calcium halophosphate wherein the average particle size of about 35% of the phosphor particles is about 3.3 microns or less.

(2) the particle size distribution is shown for both regular halophosphate phosphor and the fines phosphor containing superfines halophosphate phosphor. The regular phosphors are those that are used conventionally in the manufacture of straight TL lamps. They are identified as numbers in the heading of the columns. The particular phosphors used in the experiments reported in the Table are:

{a) cool white phosphor comprising calcium halophosphate activated with antimony and manganese having an average particle size of about 8 to about 12 microns; and

(b) a two phosphor blend of about 50% regular cool-white calcium halophosphate activated with antimony and manganese and about 50% cool-white fines calcium halophosphate activated with antimony.

(3) The first column is the particle distribution for the regular small particle cool-white halophosphate made by conventional halophosphate manufacturing known in the art. The second and third columns are for regular particle size cool-white halophosphate (no fines addition—100% regular). The columns A, B and C are the particle size distribution of various fines containing superfines phosphors (100%). On each of these, the total volume percent particle distribution between 0.409 (essentially zero) and the 3.9 micron size and between 0.49 and the 3.27 micron size is given.

(4) The mercury consumption, in micrograms, for lamps made with these phosphors is given at the bottom of the Table. It should be noted that first 3 columns are for the phosphors as displayed, but the mercury consumption values for the fines are for a 50/50 blend. For clarity, the particle size distributions for the 50/50 blends were computed using each of the fines fractions A, B, and C. This data is given in Table IA.

(5) The fines phosphors are identified as letters in Tables I and IA. At the bottom of each Table is the total volume percent of the particle size distribution. Below that is the mercury consumption determined by wet chemical analysis in our laboratory for lamps that are made with a halophosphate phosphor mixture containing 50% by weight of the phosphor superfines and 50% by weight of regular phosphor which contain no superfines addition.

TABLE I
Particle Size Distribution for Various Cool-White Halophosphate Phosphors
Listed As Volume Percent For Specific Particle Size Diameters In Microns

| | 1 | 2 | 3 | A | B | C |
|---|---|---|---|---|---|---|
| Particle Diameter | Sm. Part | Reg. | Reg. | Fines | Fines | Fines |
| (microns) | Volume % | Volume % | Volume % | Volume % | Volume % | Volume % |
| 0.409 | 0.00 | 0.00 | 0.00 | 0.00 | 0.00 | 0.00 |
| 0.486 | 0.00 | 0.00 | 0.00 | 0.00 | 0.00 | 0.00 |
| 0.578 | 0.00 | 0.00 | 0.00 | 0.00 | 0.00 | 0.00 |
| 0.688 | 0.00 | 0.00 | 0.00 | 0.00 | 0.33 | 0.00 |
| 0.818 | 0.00 | 0.00 | 0.00 | 0.59 | 0.68 | 0.00 |
| 0.972 | 0.00 | 0.00 | 0.00 | 1.14 | 1.26 | 0.43 |
| 1.156 | 0.00 | 0.00 | 0.00 | 1.96 | 1.94 | 0.61 |
| 1.375 | 0.00 | 0.00 | 0.00 | 2.88 | 2.39 | 0.66 |
| 1.635 | 0.00 | 0.00 | 0.00 | 3.77 | 2.57 | 0.54 |
| 1.945 | 0.00 | 0.00 | 0.00 | 4.70 | 2.74 | 0.36 |
| 2.312 | 0.00 | 0.00 | 0.00 | 5.74 | 3.15 | 0.00 |
| 2.750 | 0.00 | 0.34 | 0.00 | 6.81 | 3.81 | 0.00 |
| 3.270 | 0.00 | 0.65 | 0.00 | 7.90 | 4.67 | 0.00 |
| 3.889 | 0.00 | 1.31 | 0.00 | 9.28 | 5.77 | 0.00 |
| 4.625 | 0.00 | 2.62 | 0.00 | 11.15 | 7.44 | 2.98 |
| 5.500 | 5.79 | 4.88 | 1.31 | 12.82 | 10.07 | 10.94 |
| 6.541 | 11.71 | 8.02 | 4.61 | 12.89 | 13.30 | 25.04 |
| 7.778 | 17.67 | 11.37 | 10.86 | 9.53 | 14.97 | 29.61 |
| 9.250 | 20.11 | 14.12 | 17.85 | 5.44 | 12.74 | 18.57 |
| 11.000 | 17.44 | 15.84 | 21.47 | 2.45 | 7.72 | 7.12 |
| 13.080 | 11.90 | 15.93 | 19.39 | 0.93 | 3.36 | 1.95 |
| 15.560 | 6.76 | 13.24 | 13.30 | 0.32 | 1.09 | 0.43 |
| 18.500 | 3.38 | 7.96 | 7.01 | 0.00 | 0.00 | 0.00 |
| 22.000 | 1.55 | 3.04 | 2.90 | 0.00 | 0.00 | 0.00 |
| 26.160 | 0.69 | 0.68 | 1.00 | 0.00 | 0.00 | 0.00 |
| 31.110 | 0.32 | 0.00 | 0.30 | 0.00 | 0.00 | 0.00 |
| 37.000 | 0.00 | 0.00 | 0.00 | 0.00 | 0.00 | 0.00 |
| 44.000 | 0.00 | 0.00 | 0.00 | 0.00 | 0.00 | 0.00 |
| SUM | 0.00 | 0.99 | 0.00 | 35.49 | 23.54 | 2.60 |
| 0.40 to 3.27 microns | | | | | | |
| SUM | | | | | | |
| 0.40 to 3.9 microns | 0.00 | 2.30 | 0.00 | 44.77 | 29.31 | 2.60 |
| Hg Consumption | 1476 | NA | 1234 | 778 | 856 | 1169 |
| micrograms @ 1000 hr | | | | | | |

| Small | 100% Regular | 100% Fines |
|---|---|---|
| Particle | | |
| Regular | | |

It is clear the regular phosphors without superfines fraction have very high mercury consumption. Those with the superfines addition contain the lower mercury consumption. For comparison, a small-particle halophosphate phosphor is also listed. This material is similar to the regular halophosphate phosphor but is manufactured to an average smaller particle size of about 8.6 microns. (See Table IB). This material has the highest mercury consumption and illustrates that the particle size fractions specified in this invention are necessary and that smaller average particle size alone is insufficient in predicting the desired performance.

TABLE IA

| Particle | A Fines | B Fines | C Fines |
|---|---|---|---|
| Diameter | 50/50 | 50/50 | 50/50 |
| (microns) | Volume % | Volume % | Volume % |
| 0.409 | 0.00 | 0.00 | 0.00 |
| 0.486 | 0.00 | 0.00 | 0.00 |
| 0.578 | 0.00 | 0.00 | 0.00 |
| 0.688 | 0.00 | 0.17 | 0.00 |
| 0.818 | 0.30 | 0.34 | 0.00 |
| 0.972 | 0.57 | 0.63 | 0.22 |
| 1.156 | 0.98 | 0.97 | 0.31 |
| 1.375 | 1.44 | 1.20 | 0.33 |
| 1.635 | 1.89 | 1.29 | 0.27 |
| 1.945 | 2.35 | 1.37 | 0.18 |
| 2.312 | 2.87 | 1.58 | 0.00 |
| 2.750 | 3.41 | 1.91 | 0.00 |
| 3.270 | 3.95 | 2.34 | 0.00 |
| 3.889 | 4.64 | 2.89 | 0.00 |
| 4.625 | 5.58 | 3.72 | 1.49 |
| 5.500 | 7.07 | 5.69 | 6.13 |
| 6.541 | 8.75 | 8.96 | 14.83 |
| 7.778 | 10.20 | 12.92 | 20.24 |
| 9.250 | 11.65 | 15.30 | 18.21 |
| 11.000 | 11.96 | 14.60 | 14.30 |
| 13.080 | 10.16 | 11.38 | 10.67 |
| 15.560 | 6.81 | 7.20 | 6.87 |
| 18.500 | 3.51 | 3.51 | 3.51 |
| 22.000 | 1.45 | 1.45 | 1.45 |
| 26.160 | 0.50 | 0.50 | 0.50 |
| 31.110 | 0.15 | 0.15 | 0.15 |
| 37.000 | 0.00 | 0.00 | 0.00 |
| 44.000 | 0.00 | 0.00 | 0.00 |
| Total Volume Percent | 17.75 | 11.77 | 1.30 |
| 0.40 to 3.27 microns | | | |
| Total Volume Percent | 22.39 | 14.66 | 1.30 |
| 0.40 to 3.9 microns | | | |
| Hg Consumption | 778 | 856 | 1169 |
| micrograms @ 1000 hr | | | |

50% Regular/50% Fines

Table IB below shows the particle size distribution in microns of the phosphors used in Table. It is described by the average particle size (d50), the d25 (25 volume % fraction, i.e., volume percent less than this value), and d75 (75 volume % fraction) and the QD, quartile distribution. The QD is a measure of the particle size spread and is defined as QD=(d75−d25)/(d75+d25). Again the data indicates that a smaller particle size is not sufficient to identify the improved performance.

TABLE IB
Particle Size Distribution in Microns of the Phosphors:

| I.D. | Phosphor Descriptor | d50 | QD | d25 | d75 |
|---|---|---|---|---|---|
| A | Fines | 4.23 | 0.397 | 2.58 | 5.98 |
| B | Fines | 5.75 | 0.388 | 3.43 | 7.77 |
| C | Fines | 6.83 | 0.152 | 5.85 | 7.96 |
| 1 | Small Particle Regular | 8.64 | 0.228 | 6.89 | 10.95 |
| 2 | Regular | 9.97 | 0.281 | 7.34 | 13.07 |
| 3 | Regular | 10.47 | 0.211 | 8.48 | 13.02 |

TABLE II
Comparison of FBT12 TLU CW/EW Lamps With and Without Y, Sr
Borate Intermediate Layer:
(Values are listed in micrograms)

| | | Mercury | Mercury |
|---|---|---|---|
| | | Consumption | Consumption |
| Lamp ID | Coating | (as meas.) | (corrected*) |
| 13-EUG | no layer | 872 | 1272 |
| 19-EUG | no layer | 930 | 1330 |
| 4-EUG | intermediate layer | 366 | 766 |
| 6-EUG | intermediate layer | 343 | 743 |

(Lamps are coated with a 50%/50% cool-white halophosphate fines containing superfines and regular phosphors)
*400 micrograms are added to the wet chemical data to obtain the actual mercury consumption data

The above Table II shows the mercury consumption determined by wet chemical analysis for lamps with they, Sr, Borate intermediate layer and without the intermediate layer. The data show that the average mercury consumption has been reduced from an average of about 1301 micrograms to about 755 micrograms. This is a 42% reduction in the total mercury consumption. As illustrated in Table I and IA, it has been demonstrated that the mercury consumption may be reduced to about 778 micrograms. It is believed that with the intermediate layer the mercury consumption can further be reduced to at least a 58% reduction compared to lamps without the layer to an average level of at least about 451 micrograms at 1,000 hours of lamp burn.

In this embodiment of the invention, using the fines halophosphor containing superfines of the invention with an intermediate yttrium, strontium borate layer between the glass and the phosphor layer makes it possible to achieve an even further reduction in the mercury consumption compared to what has been achieved to date. This lower mercury consumption provides an enhanced life even beyond that available when using the superfines phosphor alone.

FIG. 3 is a graph illustrating the mercury consumption of a FB34T12 CW/EW U-bend lamp as a function of the superfines fraction (0.40 to 3.9 microns). The graph illustrates that the mercury consumption depends directly on the amount of the superfines fraction.

Using the models of this disclosure for producing low-mercury consuming lamps, the estimated nominal lifetime reached without the intermediate layer is about 32,000 hours. With the intermediate layer, the estimated nominal lifetime is extended to 95,000 hours. It will be seen that lamps produced according to the invention using 1) the phosphors with finer particle size distribution and 2) the intermediate coating layer between the phosphor and the envelope surface achieves a significant reduction in mercury consumption not available in the prior art. This allows for ALTO-compliant lamps with significantly longer life and/or a significantly further reduction in mercury content of the lamp.

Finally, the above-discussion is intended to be merely illustrative of the present invention and should not be construed as limiting the appended claims to any particular embodiment or group of embodiments. Thus, while the present invention has been described in particular detail with reference to specific exemplary embodiments thereof, it should also be appreciated that numerous modifications and changes may be made thereto without departing from the broader and intended spirit and scope of the invention as set forth in the claims that follow. The specification and drawings are accordingly to be regarded in an illustrative manner and are not intended to limit the scope of the appended claims.

In interpreting the appended claims, it should be understood that:

(a) the word “comprising” does not exclude the presence of other elements or acts than those listed in a given claim;

(b) the word “a” or “an” preceding an element does not exclude the presence of a plurality of such elements;

(c) any reference signs in the claims do not limit their scope;

(d) several “means” may be represented by the same item or hardware or software implemented structure or function; and

(e) each of the disclosed elements may be comprised of hardware portions (e.g., discrete electronic circuitry), software portions (e.g., computer programming), or any combination thereof.

1. A low-mercury consuming electric lamp which comprises:
A lamp envelope having an inner surface;
a source within the lamp envelope for generating ultraviolet radiation; and
a layer of a luminescent material comprising a phosphor blend comprising about 50% by weight of the phosphor blend of a halophosphate phosphor wherein the average particle size of about 25% or more of the phosphor particles is about 3.3 to 4.0 microns or less.

2. A low-mercury consuming lamp as claimed in claim 1, wherein said phosphor blend comprises a cool-white calcium halophosphate.

3. A low-mercury consuming lamp as claimed in claim 1, wherein said phosphor blend comprises:
(1) about 50% by weight of a calcium halophosphate phosphor wherein the average particle size of about 25% or 35% or more of the phosphor particles is about 3.3 to 4.0 microns or less or about 3.3 microns or less, and
(2) about 50% by weight of a calcium halophosphate phosphor wherein the average particle size is larger than about 3.3 to 4.0 microns.

4. A low-mercury consuming electric lamp which comprises:
A lamp envelope having an inner surface;
a source within the lamp envelope for generating ultraviolet radiation; and
a layer of a luminescent material comprising a phosphor blend comprising about 50% by weight of the phosphor blend of a halophosphate phosphor wherein the average particle size of about 25% or more of the phosphor particles is about 3.3 to 4.0 microns or less,
optionally, an intermediate layer of a metal borate material provided between the lamp surface and the phosphor blend layer or
optionally, an intermediate layer of a metal borate material provided between the lamp surface and the phosphor blend layer and a layer of a triband phosphor blend applied over said phosphor blend layer.

5. A low-mercury consumption electric lamp which comprises:
A lamp envelope having an inner surface;
a source within the lamp envelope for generating ultraviolet radiation; and
a layer of a luminescent material comprising a phosphor blend comprising:
about 50% by weight of the phosphor blend of a halophosphate phosphor wherein the average particle size of about 35% or more of the phosphor particles is about 3.3 microns or less, and
optionally, an intermediate layer of a Y, Sr borate material between the lamp surface and the phosphor blend layer or
optionally, an intermediate layer of a Y, Sr borate material between the lamp surface and the phosphor blend layer and a triband phosphor blend is applied over the phosphor blend layer.

6. A lamp as claimed in claim 5, wherein said phosphor blend comprises a cool-white phosphor comprising calcium halophosphate activated with antimony and manganese.

7. A lamp as claimed in claim 5, wherein said triband phosphor is a blend of europium-doped yttrium oxide, cerium/terbium lanthanum phosphate, and europium-doped barium/magnesium aluminate.

8. A lamp as claimed in claim 5, wherein said phosphor blend comprises:
(1) about 50% by weight of a calcium halophosphate phosphor wherein the average particle size of about 25% or 35% or more of the phosphor particles is about 3.3 to 4.0 microns or less or about 3.3 microns or less, and
(2) about 50% by weight of a calcium halophosphate phosphor wherein the average particle size is larger than about 3.3 to 4.0 microns.

9. A low pressure low-mercury consumption mercury vapor fluorescent lamp, comprising:
a. a tubular, light transmissive lamp envelope having opposing sealed ends, an inner tubular surface and enclosing a discharge space between said sealed ends with a volume;
b. a filling of mercury and a rare gas;
c. a pair of discharge electrodes each arranged at a respective sealed end of said lamp envelope;
d. means for connecting said discharge electrodes to a source of electric potential outside of said lamp envelope, whereby during lamp operation a gas discharge is maintained between said discharge electrodes, which gas discharge emits ultraviolet radiation;
e. a first, light transmissive and ultraviolet radiation reflecting layer disposed adjacent said inner surface of said lamp envelope, said first layer comprising a Y, Sr, borate material;
f. a layer of a luminescent material comprising a phosphor a layer of a luminescent material comprising a phosphor blend comprising:
(1) about 50% by weight of the phosphor blend of a halophosphate phosphor wherein the average particle size of about 25% or more of the phosphor particles is about 3.3 to 4.0 microns or less, and
2) about 50% by weight of a calcium halophosphate phosphor wherein the average particle size is larger than about 3.3 to 4.0 microns.

10. A lamp as claimed in claim 9, wherein said phosphor is a cool-white phosphor comprising calcium halophosphate activated with antimony and manganese.

11. A lamp as claimed in claim 10, wherein said phosphor is a phosphor blend comprising:
(1) about 50% by weight of a calcium halophosphate phosphor wherein the average particle size of about 25% or 35% or more of the phosphor particles is about 3.3 to 4.0 microns or less or 3.3 microns or less, and
(2) about 50% by weight of a calcium halophosphate phosphor wherein the average particle size is larger than about 3.3 to 4.0 microns.

12. A phosphor for a low-mercury-consuming electric lamp which comprises:
(1) about 50% by weight of a halophosphate phosphor wherein the average particle size of about 25% or 35% or more of the phosphor particles is about 3.3 to 4.0 microns or less or about 3.3 microns or less, and
(2) about 50% by weight of a halophosphate phosphor wherein the average particle size is larger than about 3.3 to 4.0 microns.

13. A phosphor as claimed in claim 12, wherein both fractions of said blend contain a cool-white calcium halophosphate.
